(19) United States
(12) Patent Application Publication
(10) Pub. No.: US 2018/0229748 A1
(43) Pub. Date: Aug. 16, 2018

(54) CARRIAGE

(71) Applicant: NABTESCO CORPORATION, Tokyo (JP)

(72) Inventors: Koji Nakamura, Tsu-shi (JP); Yudai Mitsumori, Tsu-shi (JP)

(21) Appl. No.: 15/892,614

(22) Filed: Feb. 9, 2018

(30) Foreign Application Priority Data
Feb. 15, 2017 (JP) 2017-026349

(51) Int. Cl. B62B 5/00

(52) U.S. Cl. CPC B62B 5/0069; B62B 5/003; B62B 2203/073; B62B 5/0093; B62B 5/004

(57) ABSTRACT

A carriage is used to convey a load. The carriage has a carriage body having a frame and a plurality of wheels rotatably retained to the frame, a loading platform supported to the carriage body and bearing the load, a sensor for detecting a relative movement between the carriage body and the loading platform, and a driving device for outputting a driving force based on a result of detection by the sensor to any of the plurality of wheels.

### CROSS-REFERENCE TO RELATED APPLICATIONS

This application is based on and claims the benefit of priority from Japanese Patent Application Serial No. 2017-026349 (filed on Feb. 15, 2017), the contents of which are hereby incorporated by reference in their entirety.

### TECHNICAL FIELD

The present invention relates to a carriage used to convey a load.

### BACKGROUND

For example, a carriage disclosed in Japanese Patent Application Publication No. 2016-117420 is assisted in traveling by use of a driving force from a drive source such as a motor. In this carriage, a handle for steering a steering wheel is provided with a switch for controlling an output of the driving force. Thus, an operator can operate the switch with the same hand that grips the handle so as to adjust an output of the driving force.

It cannot be said, however, that operating the switch at every time of adjusting an output of a driving force provides excellent operability. Furthermore, due to such poor operability, it is also assumed that a driving force is always kept outputted regardless of a traveling environment. Specifically, it is also expected that even after the carriage has completed climbing a slope or after the carriage has got over a step height, a driving force is left being outputted due to troublesomeness of operating the switch, which is not preferable also from the viewpoint of energy saving.

### SUMMARY

The present invention has been made in view of the foregoing, and an object of the present invention is to improve operability of a carriage assisted in traveling by being supplied with a driving force. A carriage according to the present invention is a carriage used to convey a load and is provided with a carriage body having a frame and a plurality of wheels rotatably retained to the frame, a loading platform supported to the carriage body and bearing the load, a sensor for detecting a relative movement between the carriage body and the loading platform, and a driving device for outputting a driving force based on a result of detection by the sensor to any of the plurality of wheels.

In the carriage according to the present invention, a configuration may be adopted in which the sensor includes a first sensor and a second sensor spaced apart from each other in a width direction of the carriage body, the plurality of wheels include a first wheel and a second wheel spaced apart from each other in the width direction of the carriage body, and the driving device includes a first driving device and a second driving device, the first driving device outputting a driving force based on a result of detection by the first sensor to the first wheel, and the second driving device outputting a driving force based on a result of detection by the second sensor to the second wheel.

According to the present invention, it is possible to improve operability of a carriage assisted in traveling by being supplied with a driving force.

### BRIEF DESCRIPTION OF THE DRAWINGS

FIG. 1 is a view for explaining one embodiment of the present invention, showing a side view of a carriage.

FIG. 2 is a plan view showing the carriage from below.

FIG. 3 is a block diagram related to control of a driving force.

FIG. 4 is a view corresponding to FIG. 1 for explaining an action of the carriage.

FIG. 5 is a plan view showing a carriage body from above for explaining an action of the carriage.

### DESCRIPTION OF THE PREFERRED EMBODIMENTS

One embodiment of the present invention will now be described with reference to the appended drawings. In the drawings appended hereto, scales, aspect ratios, and so on have been appropriately altered for emphasis so as to facilitate illustration and understanding of the drawings.

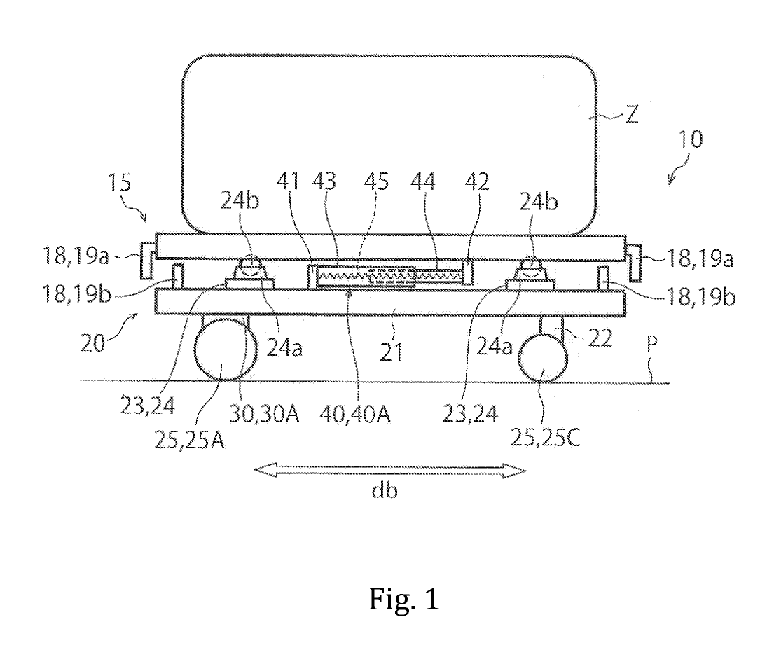

FIG. 1 to FIG. 5 are views for explaining one embodiment of the present invention. In one embodiment described below, a carriage 10 is a device used to convey a load Z. The carriage 10 has a carriage body 20 having a wheel 25, a loading platform 15 retained to the carriage body 20, and a driving device 30 for driving the wheel 25 to rotate. In the carriage 10, a driving force is outputted from the driving device 30 to the wheel 25 so as to assist the carriage 10 in traveling by being pushed by an operator.

Particularly, the carriage 10 described in this embodiment is designed with some thought to improve operability. To be more specific, without entailing intentionally operating a switch or the like, a driving force for assisting the carriage 10 in traveling is outputted based on a traveling state of the carriage 10, a force applied by an operator, or the like. In a specific configuration, the carriage 10 has a sensor 40 for detecting a relative movement between the carriage body 20 and the loading platform 15 and a control portion 50 for controlling the driving device 30 based on a result of detection by the sensor 40. The following sequentially describes these various constituent components.

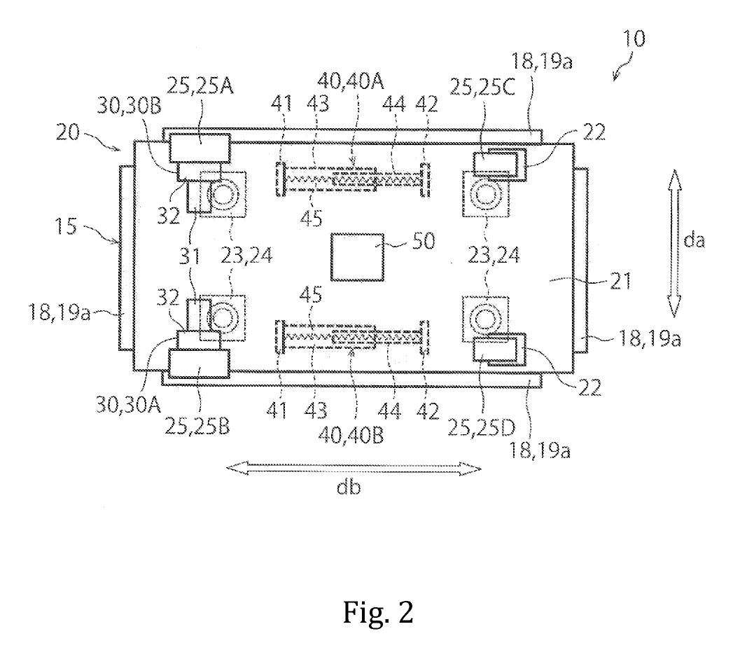

First, a description is given of the carriage body 20 and the loading platform 15. As shown in FIG. 1 and FIG. 2, the loading platform 15 is supported by the carriage body 20. The loading platform 15 is where the load Z is to be loaded. In an example shown, the loading platform 15 is a plate-shaped member and has a rectangular shape in plan view. The loading platform 15, however, may be a box-shaped member having a bottom plate, a side wall, and so on or may be a basket-shaped member having a bottom plate and a side frame.

The carriage body 20 has four wheels 25 and a frame 21 rotatably retaining the wheels 25. Furthermore, the carriage body 20 further has a retaining mechanism 23 for retaining the loading platform 15. In the example shown, the frame 21 has a rectangular shape in plan view. Particularly, the frame 21 has the same shape in plan view as that of the loading platform 15.

As shown in FIG. 2, the carriage body 20 shown has a first wheel 25A constituting a right-side rear wheel, a second wheel 25B constituting a left-side rear wheel, a third wheel 25c constituting a right-side front wheel, and a fourth wheel 25D constituting a left-side front wheel. The first wheel 25A and the second wheel 25B are spaced apart from each other in a width direction da of the carriage 10. The third wheel 25C and the fourth wheel 25D are also spaced apart from each other in the width direction da of the carriage 10. Furthermore, the first wheel 25A and the third wheel 25C are spaced apart from each other in a front-rear direction (a traveling direction) db of the carriage 10. The second wheel 25B and the fourth wheel 25D are also spaced apart from each other in the front-rear direction db of the carriage 10.

In the example shown, the first wheel 25A and the second wheel 25B are rotatably retained to the carriage body 20. A rotation axis of each of the first wheel 25A and the second wheel 25B is parallel to the width direction da of the carriage 10 and perpendicular to the front-rear direction db of the carriage 10. On the other hand, each of the third wheel 25C and the fourth wheel 25D is retained to the frame 21 via a caster mechanism 22. The caster mechanism 22 is mounted to the frame 21. The caster mechanism 22 retains each of these wheels 25 rotatably about a rotation axis of the each of these wheels 25 and retains the each of these wheels 25 swivelably about a caster axis perpendicular to the rotation axis thereof.

A configuration of the carriage body 20 shown is only illustrative. For example, the number of the wheels 25 is not limited to four and may be three or five or more. As one specific example, the carriage body 20 may be configured to have a pair of rear wheels and one front wheel. Furthermore, while in the example shown, the frame 21 has a rectangular shape in plan view, there is no limitation thereto. The frame 21 can adopt various configurations in which the wheels 25 can be rotatably retained and the loading platform 15 can be supported.

As shown in FIG. 1, the retaining mechanism 23 is disposed at a position on the carriage body 20 opposed to the loading platform 15. In the example shown, the retaining mechanism 23 is provided on an upper surface of the frame 21. The retaining mechanism 23 supports the loading platform 15 so that the loading platform 15 is movable relative to the frame 21. As the retaining mechanism 23 shown, a ball transfer 24 is used. The ball transfer 24 has a base 24a secured to the frame 21 and a spherical body 24b retained rotatably about any axis with respect to the base 24a. As shown in FIG. 2, four ball transfers 24 are spaced apart from each other in the width direction da and the front-rear direction db.

As shown in FIG. 1, the loading platform 15 is disposed on the respective spherical bodies 24b of the ball transfers 24. The spherical bodies 24b each rotate with respect to the base 24a, causing the loading platform 15 to move relative to the carriage body 20. Particularly in the example shown, the loading platform 15 is positioned on the carriage body 20 and is movable on a virtual plane parallel to a travel surface P.

A surface on the loading platform 15 where contact is made with each of the ball transfers 24 may be in the shape of an inclined surface such as, for example, a side surface of a cone. According to this configuration, in a case where no external force is applied to the carriage 10 when disposed on a horizontal plane, the loading platform 15 is disposed at a fixed reference position with respect to the carriage body 20. Furthermore, while the retaining mechanism 23 is provided on the carriage body 20 in the above-mentioned example, there is no limitation thereto, and the retaining mechanism 23 may be provided on the loading platform 15.

As shown in FIG. 1 and FIG. 2, a stopper mechanism 18 is provided in the carriage 10. The stopper mechanism 18 restricts a range in which the loading platform 15 is movable with respect to the carriage body 20. In the example shown, a stopper member 19a is provided at each of four sides of the loading platform 15. In FIG. 1, some of the stopper members 19a are not shown. Furthermore, on the frame 21 of the carriage body 20, a securing piece 19b is provided so as to correspond to each of the stopper members 19a. The securing piece 19b is provided on the upper surface of the frame 21. As the loading platform 15 moves relative to the carriage body 20, the stopper member 19a comes into contact with the securing piece 19b. Then, as a result of contact between the stopper member 19a and the securing piece 19b, a movement of the loading platform 15 with respect to the carriage body 20 is restricted. The stopper mechanism 18 is not limited to that in the example shown and can have various configurations. For example, a configuration may be adopted in which the stopper member 19a makes contact with an edge portion of the frame 21 instead of with the securing piece 19b, so that a relative movement between the loading platform 15 and the carriage body 20 is restricted.

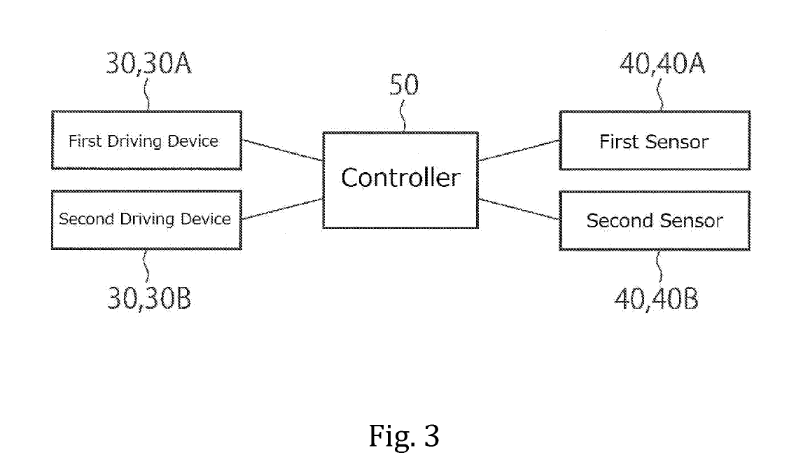

Next, a description is given of the driving device 30, the sensor 40, and the control portion 50. As shown in FIG. 3, the control portion 50 is electrically connected to the driving device 30 and to the sensor 40. As mentioned above, the sensor 40 detects a relative movement between the carriage body 20 and the loading platform 15. The control portion 50 controls the driving device 30 based on a result of detection by the sensor 40. The driving device 30 outputs a driving force based on the result of detection by the sensor 40 to any of the wheels 25. The carriage 10 is provided with an unshown battery, and thus the driving device 30 can operate by being supplied with power from this battery.

In the example shown, the sensor 40 includes a first sensor 40A and a second sensor 40B spaced apart from each other in the width direction da of the carriage body 20. The driving device 30 includes a first driving device 30A and a second driving device 30B. The first driving device 30A outputs, to the first wheel 25A, a driving power based on a result of detection by the first sensor 40A. The second driving device 30B outputs, to the second wheel 25B, a driving power based on a result of detection by the second sensor 40B.

Each of the driving devices 30 has, as one example, a drive source 31 and a speed reducer 32. As the drive source 31, for example, a motor or an engine can be used. The speed reducer 32 reduces a speed of rotation outputted from the drive source 31 so that an increased torque is obtained, and outputs the rotation with the increased torque to a corresponding one of the wheels 25. As the speed reducer 32, for example, an eccentric oscillating speed reducer, a speed reducer using a planetary gear, or a combination of these can be used. The driving device 30 may be configured without including the speed reducer 32. Furthermore, the driving device 30 may include another mechanism such as a clutch capable of switching between transmission and shutoff of rotational power.

Next, a description is given of the sensor 40. In the example shown, the sensor 40 is configured as a slide-type switch. Thus, the sensor 40 is configured to be expandable and contractible and acquires information related to an amount of expansion and an amount of contraction.

The sensor 40 shown has a first component 43 and a second component 44 movable relative to each other in one direction. The first component 43 and the second component 44 are both formed of a cylindrical member. In the example shown, the first component 43 has a diameter larger than that of the second component 44, and part of the second component 44 is inserted into the first component 43. Furthermore, a biasing member 45 is provided in the first component 43 and the second component 44. The biasing member 45 is providing a bias so that the first component 43 and the second component 44 are positioned at a reference position. In a case where a combined body of the first component 43 and the second component 44 is in an expanded state, the biasing member 45 provides a bias so that the first component 43 and the second component 44 are brought close to each other. On the other hand, in a case where the combined body of the first component 43 and the second component 44 is in a contracted state, the biasing member 45 provides a bias so that the first component 43 and the second component 44 are separated from each other.

The sensor 40 further has a first sensor base 41 used to mount the first component 43 to the carriage body 20 and a second sensor base 42 used to mount the second component 44 to the loading platform 15. The first sensor base 41 secures the first component 43 in the front-rear direction db with respect to the carriage body 20. The second sensor base 42 secures the second component 44 in the front-rear direction db with respect to the loading platform 15. Thus, in a case where the loading platform 15 and the carriage body 20 move relative to each other in the front-rear direction db, the first component 43 and the second component 44 move relative to each other in an axial direction (a longitudinal direction) thereof. From the viewpoint of allowing a relative movement between the loading platform 15 and the carriage body 20 in the width direction da, a configuration may be adopted in which the first sensor base 41 is used to swingably mount the first component 43 to the carriage body 20, and the second sensor base 42 is used to swingably mount the second component 44 to the loading platform 15.

The sensor 40 is capable of measuring a relative position between the first component 43 and the second component 44. For example, similarly to a so-called potentiometer, the sensor 40 may have a configuration capable of detecting a relative movement between the first component 43 and the second component 44 along the axial direction (the longitudinal direction) of the combined body of the first component 43 and the second component 44. As another example, the sensor 40 may have a configuration capable of measuring a total length of the combined body of the first component 43 and the second component 44 along the axial direction (the longitudinal direction) thereof. As still another example, the sensor 40 may have a configuration capable of measuring a separation distance between the first sensor base 41 and the second sensor base 42 or a separation length between the first sensor base 41 and the second sensor base 42 along the front-rear direction db. A measurement mechanism of the sensor 40 for actually performing a measurement is not particularly limited and can take various forms such as a resistive type, a photoelectric type, a magnetic type, and so on.

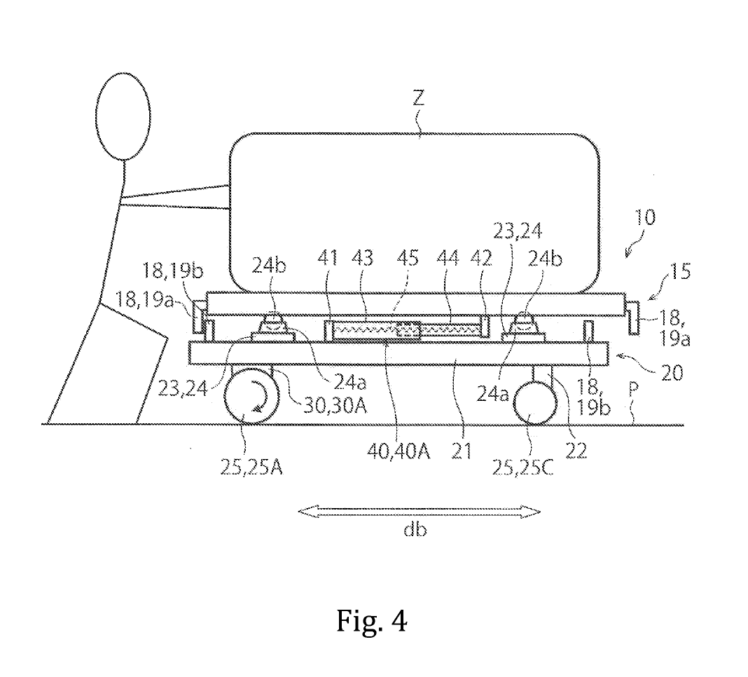

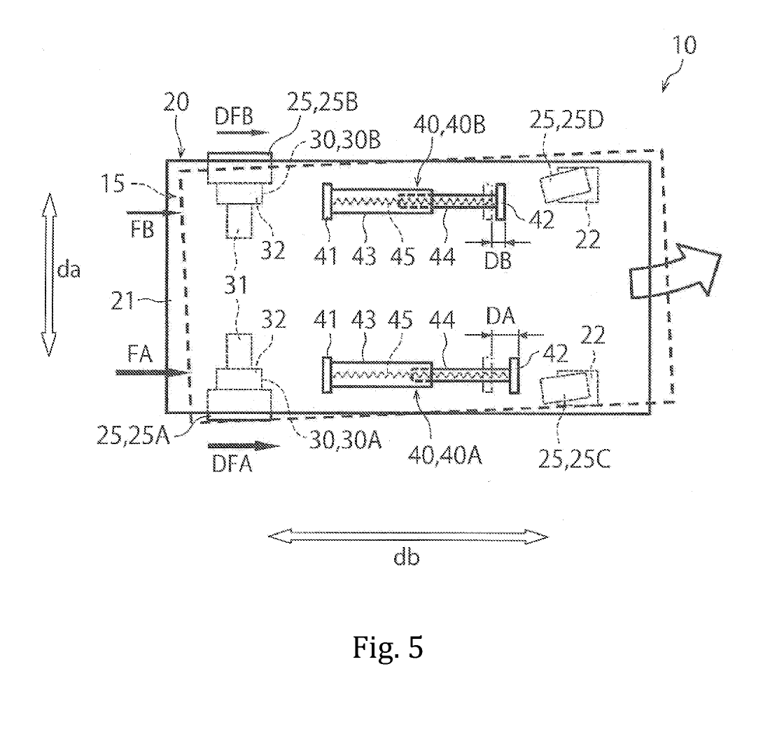

The control portion 50 performs an arithmetic operation on an output result from the sensor 40 and, based on a result of the arithmetic operation, adjusts a driving force outputted from the driving device 30 to a corresponding one of the wheels 25. As shown in FIG. 4 and FIG. 5, in a case where one of the slide-type sensors 40 shown is expanded in the axial direction (the longitudinal direction, a sliding direction) thereof against a biasing force of the biasing member 45, that is, in a case where the first component 43 and the second component 44 are separated from each other, one of the driving devices 30 corresponding to the one of the slide-type sensors 40 outputs a driving force for causing forward travel to a corresponding one of the wheels 25. The driving force for causing forward travel increases with increasing amount of expansion of the sensor 40. Conversely, in a case where one of the slide-type sensors 40 is contracted in the axial direction (the longitudinal direction, the sliding direction) thereof against a biasing force of the biasing member 45, that is, in a case where the first component 43 and the second component 44 are brought close to each other, one of the driving devices 30 corresponding to the one of the slide-type sensors 40 outputs a driving force for causing rearward travel to a corresponding one of the the wheels 25. The driving force for causing rearward travel increases with increasing amount of contraction of the sensor 40.

The term “forward (forward travel)” mentioned herein refers to a side toward the front wheels 25C and 25D in the front-rear direction, namely, in a direction perpendicular to the rotation axis of each of the rear wheels 25A and 25B, which are not casters (refers to traveling toward the front wheels 25C and 25D). On the other hand, the term “rearward (rearward travel)” refers to a side toward the rear wheels 25A and 25B in the front-rear direction (refers to traveling toward the rear wheels 25A and 25B).

Control of a driving force by the control portion 50, however, is not limited to the above-described example. For example, a configuration may be adopted in which the carriage body 20 includes other various sensors such as a contact sensor (a grip sensor) and a speed sensor, and outputs from these various sensors are also considered in controlling a driving force outputted from the driving device 30 to a corresponding one of the wheels 25.

Next, a description is given of a method for using the carriage 10 having the above-mentioned configuration.

First, the load Z is loaded on the loading platform 15 of the carriage 10. The carriage 10 shown has no handle, frame, or the like, and thus, the variously shaped load Z can be loaded on the loading platform 15. Furthermore, a plurality of loads Z can be loaded with less limitation on how they are piled up.

As shown in FIG. 4, an operator pushes the load Z on the loading platform 15 and thus can cause the carriage 10 to travel. In a case where the carriage 10 is caused to travel by pushing the load Z or the loading platform 15, the carriage body 20 receives resistance from the travel surface P, so that the loading platform 15 and the load Z move relative to the carriage body 20 in a travel direction of the carriage 10. Depending on a situation where the load Z is heavy, the travel surface P is in a poor condition, or the travel surface P is an uphill slope, that is, when a force required to cause the carriage 10 to travel increases, a relative movement amount of the loading platform 15 with respect to the carriage body 20 increases.

In a state shown in FIG. 4, the operator is pushing the carriage 10 from a rear side of said carriage 10 in the front-rear direction db. At this time, the loading platform 15 and the load Z move forward in the front-rear direction db relative to the carriage body 20. Thus, in a state shown in FIG. 4, the sensor 40 is deformed so that a total length thereof is expanded along the axial direction thereof. The sensor 40 is expanded in this manner, thus detecting that the loading platform 15 has moved forward in the front-rear direction db relative to the carriage body 20. The control portion 50 receives a result of detection by the sensor 40 and, based on the result of detection by the sensor 40, controls the driving device 30 to output a driving force for causing forward travel to a corresponding one of the wheels 25. That is, a driving force is imparted as a force for assisting the operator in pushing the carriage 10. In other words, a direct action itself of pushing the carriage 10 constitutes a condition for starting supply of a driving force. A driving force is generated without requiring that the operator release his/her hand from the load Z and operate a switch or the like.

Furthermore, in the carriage 10, as a force required to cause the carriage 10 to travel increases, a deformation amount of the sensor 40 increases. Thus, as a force required to cause the carriage 10 to travel increases, a driving force outputted to a corresponding one of the wheels 25 increases. That is, a magnitude of a force applied by an operator to push the carriage 10 constitutes a condition for determining a magnitude of a driving force supplied to a corresponding one of the wheels 25. Thus, when there is a step height on the travel surface P, an operator applies an increased force so that the carriage 10 can get over said step height. At this time, the driving device 30 also supplies an increased driving force to a corresponding one of the wheels 25. Furthermore, after the carriage 10 has got over said step height, it becomes sufficient that the operator applies a decreased force thereto. At this time, a driving force outputted from the driving device 30 also becomes weaker. Thus, an unwanted output of a driving force is suppressed, and thus, for example, useless consumption of a battery can be avoided. That is, energy saving can be achieved.

Also in a case where, unlike the state shown in FIG. 4, an operator pushes the carriage 10 from a front side of said carriage 10 in the front-rear direction db, a driving force is supplied based on a direct action by the operator. In a case where the operator pushes the carriage 10 from the front side to the rear side in the front-rear direction db, the loading platform 15 moves rearward in the front-rear direction db relative to the carriage body 20, and the sensor 40 is deformed so that a total length thereof is contracted along the axial direction thereof. As a result, based on a result of detection by the sensor 40, the control portion 50 controls the driving device 30 to output a driving force for causing rearward travel to a corresponding one of the wheels 25. That is, also in this case, a driving force is imparted as a force for assisting the operator in pushing the carriage 10.

Furthermore, in the example shown, the sensor 40 includes the first sensor 40A and the second sensor 40B spaced apart from each other in the width direction da of the carriage body 20. The driving device 30 includes a first driving device 30A and a second driving device 30B, the first driving device 30A outputting a driving force based on a result of detection by the first sensor 40A to the first wheel 25A, and the second driving device 30B outputting a driving force based on a result of detection by the second sensor 40B to the second wheel 25B. The first wheel 25A and the second wheel 25B are spaced apart from each other in the width direction da of the carriage body 20. In a case where, as shown in FIG. 5, an operator intends to cause the carriage body 20 to swivel to the left, the operator pushes a right rear side of the carriage 10 with an increased force FA and a left rear side thereof with a decreased force FB. As a result, with respect to the first sensor 40A and the second sensor 40B spaced apart from each other in the front-rear direction db, a deformation amount DA of the first sensor 40A and a deformation amount DB of the second sensor 40B vary from each other. The amount DA of expansion of the first sensor 40A receiving the stronger force FA increases, and the amount DB of expansion of the second sensor 40B receiving the weaker force FB decreases. Thus, a driving force DFA outputted from the first driving device 30A based on a deformation amount of the first sensor 40A increases, and a driving force DFB outputted from the second driving device 30B based on a deformation amount of the second sensor 40B decreases. As a result, a driving force outputted from the driving device 30 also acts to cause the carriage 10 to swivel to the left. That is, in the carriage 10, based on a force applied to the carriage 10 so as to cause the carriage 10 to swivel, a driving force for causing the carriage 10 to swivel is supplied to a corresponding one of the wheels 25.

As described above, in the foregoing one embodiment, the carriage 10 used to convey the load Z has the carriage body 20 having the frame 21 and the plurality of wheels 25 rotatably retained to the frame 21, the loading platform 15 supported to the carriage body 20 and bearing the load Z, the sensor 40 for detecting a relative movement between the carriage body 20 and the loading platform 15, and the driving device 30 for outputting a driving force based on a result of detection by the sensor 40 to any of the plurality of wheels 25. According to the carriage 10 described above, the loading platform 15 moves relative to the carriage body 20, and a driving force based on this relative movement is outputted from the driving device 30 to a corresponding one of the wheels 25. A movement of the loading platform 15 relative to the carriage body 20 is induced by an operator pushing the carriage 10. That is, based on a force for operating the carriage 10 applied by an operator, a driving force for causing the carriage 10 to achieve travel intended by the operator is outputted. Thus, it becomes possible to significantly improve operability of the carriage 10 assisted in traveling by being supplied with a driving force.

Various modifications can be made to the foregoing embodiment. For example, while the foregoing one embodiment has shown an example in which the carriage 10 is not provided with a handle for an operator to grasp when performing an operation, there is no limitation thereto. In a case where such a handle is mounted to the loading platform 15, similarly to a force applied to the load Z in the foregoing one embodiment, a force applied to the handle can cause a relative movement between the loading platform 15 and the carriage body 20. Thus, in this modification example, even in a case where a force is applied to the handle, or a case where a force is directly applied to the load Z for reasons such as that the handle is hard to grasp due to, for example, the shape of the load Z, similarly to the foregoing one embodiment, it becomes possible to significantly improve operability of the carriage 10 assisted in traveling by being supplied with a driving force.

What is claimed is:

1. A carriage used to convey a load, comprising:
a carriage body having a frame and a plurality of wheels rotatably retained to the frame;
a loading platform supported to the carriage body and bearing the load;
a sensor for detecting a relative movement between the carriage body and the loading platform; and
a driving device for outputting a driving force based on a result of detection by the sensor to any of the plurality of wheels.

2. The carriage according to claim 1, wherein the sensor includes a first sensor and a second sensor spaced apart from each other in a width direction of the carriage body,
the plurality of wheels include a first wheel and a second wheel spaced apart from each other in the width direction of the carriage body, and
the driving device includes a first driving device and a second driving device, the first driving device outputting a driving force based on a result of detection by the first sensor to the first wheel, and the second driving device outputting a driving force based on a result of detection by the second sensor to the second wheel.
